(19) United States
(12) Patent Application Publication
(10) Pub. No.: US 2009/0071397 A1
(43) Pub. Date: Mar. 19, 2009

(54) ROTARY ATOMIZER HEAD TYPE PAINING MACHINE

(75) Inventors: Shinichi Yasuda, Shizuoka (JP); Toshifumi Matsuura, Shizuoka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ABB K.K., Shibuya-ku (JP)

(21) Appl. No.: 12/280,858

(22) PCT Filed: Jul. 6, 2007
(86) PCT No.: PCT/JP2007/063937

§ 371 Date: Aug. 27, 2008

(30) Foreign Application Priority Data
Jul. 19, 2006 (JP) 2006-197204

(51) Int. Cl. B05B 3/02

(52) U.S. Cl. 118/300

(57) ABSTRACT

A coupling portion is provided on an outer peripheral side of a rotational shaft, a stationary ring is mounted on a fore end portion of an air motor, a rotatable ring is rotatably attached to a stationary ring, and slide plates are provided between the stationary ring and the rotatable ring movably in radially inward and outward directions of the rotational shaft. A slider shift mechanism provided on the stationary ring and the rotatable ring brings each slide plate into and out of engagement with the coupling portions in step with a rotational movement of the rotatable ring. Thus, for locking the rotational shaft in a fixed state, an operator grips and turns the rotatable ring with one hand to engage the slide plates with the coupling portions by the slider shift mechanism. In this state, a rotary atomizing head can be mounted on or dismantled from the rotational shaft.

### TECHNICAL FIELD

This invention relates to a rotary atomizing head type coating machine suitable for use, for example, in painting vehicle bodies, furniture surfaces, electric appliances and the like.

### BACKGROUND ART

Generally, because of high paint deposition efficiency and higher finish quality, rotary atomizing head type coating machines have been resorted to in painting vehicle bodies, furniture surfaces and electric appliances. For example, a rotary atomizing head type coating machine is largely composed of a tubular housing which is mounted on a distal end of an arm of a coating robot, an air motor for driving at a high speed a rotational shaft which is accommodated in the housing, a bell- or cup-shaped rotary atomizing head which is mounted on a fore end portion of the rotational shaft on the front side of the housing, and a paint passage for circulation of paint to be supplied to the rotary atomizing head.

In a rotary atomizing head type coating machine of this sort, together with the rotational shaft, the rotary atomizing head is put in high speed rotation by the air motor while paint is spurted into the rotary atomizing head through the paint passage. The paint supplied from the paint passage is sprayed forward by the rotary atomizing head in a finely divided form for deposition on a work piece.

When changing a paint color, a wash fluid and compressed air are spurted into the rotary atomizing head from the paint passage to wash away residues (deposit) of a previous color in the paint passage and the rotary atomizing head before supplying a new color to the rotary atomizing head.

In this regard, it is important to note that deposition of paint tends to occur easily in minute grooves, holes, gap spaces or angular corners which exist in paint passages in a rotary atomizing head. Therefore, in a coating operation involving repeated color changes, paint of previous colors tends to deposits little by little in these portions which are easy to deposit. In order to carry out an elaborate and thorough cleaning operation on a rotary atomizing head in a dismantled state from the rotational shaft, in most cases rotary atomizing head type coating machines employ a rotary atomizing head which is arranged to be easily threaded on or off a fore end portion of a rotational shaft.

More particularly, concerning to a rotary atomizing head type coating machine, a male screw is tapped around the circumference of a fore end portion of the rotational shaft, a female screw is tapped on the inner periphery of a tubular mount portion of the rotary atomizing head to engage with a male screw. In a case where a rotary atomizing head is adapted to be threaded on a rotational shaft by way of engagement of such male and female screws, it is often the case that the rotational shaft which is supported on an air motor is turned together with the rotary atomizing head, upon unscrewing the rotary atomizing head for a dismantling purpose.

In this regard, there have been rotary atomizing head type coating machines which are arranged to fix a rotational shaft to a housing to prevent same from rotating together with a rotary atomizing head at the time of threading the atomizing head on or off the rotational shaft for a mounting or dismantling the purpose. In the case of a rotary atomizing head type coating machine of this sort, a recess is provided on the circumference of a fore end portion of a rotational shaft, while a stopper pin is threaded into a housing for protrusion into and out of the recess radially (e.g., see Patent Literature 1: Japanese Patent Laid-Open No. H4-71656).

More particularly, at the time of mounting or dismantling a rotary atomizing head, the stopper pin is threaded into a housing for a movement in a direction radially inward toward the rotational shaft until a fore end portion of the stopper pin is engaged with the recess on the rotational shaft. By so doing, the rotational shaft is held in a fixed state, without rotating together with the rotary atomizing head when the rotary atomizing head is turned at the time of mounting or dismantling the same on or from the rotational shaft.

In the case of the coating machine described in Patent Literature 1 mentioned above, a stopper pin is threaded into a housing for a movement in a direction radially inward of the housing. For fixing the rotational shaft, however, the stopper pin needs to be turned for many times. That is to say, mounting or dismantling a rotary atomizing head on or off a rotational shaft has been a troublesome and time-consuming job.

Further, in the case of the coating machine in Patent Literature 1, the stopper pin is arranged to protrude movably in a radial direction from an outer peripheral side of the housing. Therefore, paint tends to deposit on a protruded portion of the stopper pin, coupled with a problem that it is difficult to wash away paint which has gotten into a gap space between the stopper pin and the housing. Defoliation of part of a paint deposit on the stopper pin can result in a coating defect or defects which will impair the quality of coatings and reliability of the machine as well.

On the other hand, in the case of the coating machine in Patent Literature 1 above, a single recess is provided on the rotational shaft, and a fore end of the stopper pin is driven into the recess to lock the rotational shaft against rotation with the rotary atomizing head. Therefore, when a turning force is exerted on the rotational shaft by the rotation of the rotary atomizing head, the rotational shaft which is in engagement with the stopper pin only at one radial position is subjected to a large load in a radial direction tending to bend the rotational shaft at the point of engagement with the stopper pin.

Exertion of such a radial load on the rotational shaft, however, may result in a damage to a turbine or bearing of the air motor or bending deformation of the rotational shaft. Especially in the case of recent rotary atomizing head type coating machines in which a rotary atomizing head is put in high speed rotation as high as 3,000 to 100,000 rpm, a slight damage or deformation could pose detrimental effects on the quality of coated products.

### DISCLOSURE OF THE INVENTION

In view of the above-discussed problems with the prior art, it is an object of the present invention to provide a rotary atomizing head type coating machine which is arranged to lock a rotational shaft in a fixed state by one-touch action, to facilitate an assembling or disassembling work onto or from the rotational shaft.

It is another object of the present invention to provide a rotary atomizing head type coating machine which is arranged to lock a rotational shaft at the time of mounting or dismantling a rotary atomizing head, without applying unduly large radial loads to guarantee higher quality of coatings and higher operational reliability as well.

(1) According to the present invention, there is provided a rotary atomizing head type coating machine composed of an air motor for putting a rotational shaft in rotation, and a rotary atomizing head threaded on a fore end portion of the rotational shaft of the air motor and adapted to spray paint supplied by the rotation of the air motor.

In order to solve the above-discussed problems, the rotary atomizing head type coating machine according to the present invention is characterized by the provision of: a coupling portion provided on an outer peripheral surface of the rotational shaft at a position between the air motor and the rotary atomizing head; a stationary ring provided on the air motor in such a way as to circumvent the coupling portion; a rotatable ring rotatably attached to the stationary ring; a slider provided movably to the radial direction of the rotational shaft at a position between the stationary ring and the rotatable ring; a slider shift mechanism provided on the stationary ring and the rotatable ring to shift the slider in a radial direction of the rotational shaft in step with a rotational movement of the rotatable ring, bringing the slider into and out of engagement with the coupling portion; and the slider fixing and locking the rotation of the rotational shaft when engaged with the coupling portion by the slider shift mechanism, and the slider leaving the rotational shaft in a rotatable state when shifted radially away from the coupling portion.

With the arrangements just described, at the time of dismantling the rotary atomizing head from the rotational shaft, for example, what is required of an operator is simply to grip and turn the rotatable ring in an arbitrary direction with one hand. Whereupon, a rotational movement of the rotatable ring is translated into a radial direction movement of the rotational shaft by the slider shift mechanism, shifting the slider radially inward toward the rotational shaft to bring the slider into engagement with the coupling portion on the rotational shaft.

When the slider is engaged with the coupling portion of the rotational shaft in this manner, the rotational shaft is fixed and locked against rotation and the rotary atomizing head alone can be turned relative to the rotational shaft to permit quick and easy dismantling of the rotary atomizing head. Conversely, the rotary atomizing head can be mounted on the rotational shaft which is fixed in a non-rotatable state. Upon turning the rotatable ring in the opposite direction, the slider shift mechanism can make the slider engaged with the coupling portion to shift in a radially outward direction away from the rotational shaft to put the latter in a free rotatable state.

Thus, simply by a one-touch action (by a single action) of turning the rotatable ring, the rotational shaft can be fixed and locked against rotation, permitting to carry out disassembling, assembling and washing of the rotary atomizing head readily in a facilitated manner in such a way as to guarantee higher productivity and easy maintenance.

(2) According to the present invention, the coupling portion is provided at a plural number of positions on and around a circumferential surface of the rotational shaft, and a plural number of sliders are provided in association with a corresponding number of the coupling portions.

By so arranging, the respective coupling portions of the rotational shaft can be gripped by the respective sliders from radially opposite directions. Thus, the rotational shaft can be fixed by the respective sliders securely right on a center axis even when a rotational force is applied to the rotational shaft when mounting or dismantling the rotary atomizing head.

That is to say, there is no possibility of forcible loads being applied to the rotational shaft and air motor in a radial direction while mounting or dismantling the rotary atomizing head. It follows that the rotational shaft and the air motor can have a prolong life span, ensuring higher quality of coatings and higher operational reliability as well.

(3) According to the present invention, the slider shift mechanism comprises a radial direction guide provided on the stationary ring to guide the slider straight in a radial direction of the rotational shaft, and a rotational direction guide provided on the rotatable ring to shift the slider in a radially inward or outward direction along the radial direction guide in step with a rotational movement of the rotatable ring.

With the arrangement just described, upon turning the rotatable ring, a rotational movement of the rotatable ring is translated into a straight radial movement of the rotational shaft by cooperative actions of the radial direction guide and rotational direction guide to shift the slider in a radially outward or inward direction.

Thus, at the time of fixing the rotational shaft, the slider is shifted in a radially inward direction by the slider shift mechanism and engaged with the coupling portion on the rotational shaft. Conversely, at the time of releasing the rotational shaft in a freely rotatable state, the slider is shifted in a radially outward direction away from the rotational shaft to disengage from the coupling portion.

(4) According to the present invention, the stationary ring and the rotatable ring are confronted face to face on the front side of the air motor; the radial direction guide is formed straight in a radial direction on a confronting surface of the stationary ring; the rotational direction guide being in the form of an arcuate groove extended to a rotational direction and displaced in a radial direction is provided on a confronting surface of the rotatable ring; and the slider is engaged with both of the radial direction guide and the rotational direction guide.

With the arrangements just described, the slider is held in engagement with the radial direction guide on a confronting face of the stationary ring movably in a radial direction, and at the same time held in engagement with the rotational direction guide in the form of an arcuate groove on a confronting face of the rotatable ring. Therefore, upon turning the rotatable ring, the slider which is restricted to a radial movement by the radial direction guide is shifted in a radially inward or outward direction by the rotational direction guide in the form of a groove which is gradually shifted in radial direction.

Further, the slider can be located within the rotatable ring in a concealed position which cannot be viewed from outside. Therefore, the outer configuration of the machine can be put in a smooth shape free of hollow or projected surfaces to suppress paint deposition to a minimum, giving a better look to the machine.

Furthermore, the rotational direction guide which is formed in the shape of an arcuate groove can constantly restrain the slider from an inadvertent movement, precluding possibilities of the slider inadvertently falling into contact with the rotational shaft which is in rotation, ensuring high operational reliability.

(5) According to the present invention, the rotatable ring is located in such a way as to circumvent the stationary ring from outer peripheral side; the radial direction guide extended straight in a radial direction on the stationary ring inward of the rotatable ring; the rotational direction guide being in the form of a groove extended to a rotational direction and having a varying depth is formed on inner peripheral side of the rotatable ring; and the slider is held in engagement with both of the radial direction guide and the rotational direction guide.

In this case, the slider is engaged with a radial direction guide on the stationary ring movably straight in a radial direction and at the same time held in engagement with a rotational direction guide which is provided inside of the rotatable ring in the form of a groove having a varying depth. Therefore, upon turning the rotatable ring, the slider which is restricted of a movement other than a straight radial movement by the radial direction guide is shifted in a radially inward or outward direction along the bottom surface of the rotational direction guide which is varied in depth.

Further, since the slider can be located internally of the rotatable ring, in a concealed position which cannot be viewed from outside, the outer configuration of the machine can be put in a smooth shape without hollow or bulging surfaces to suppress paint deposition while giving a better look to the machine.

(6) According to the present invention, the stationary ring and the rotatable ring are adapted to form a shaping air ring to spurt shaping air toward the rotary atomizing head.

In this case, the stationary ring and rotatable ring are arranged to form a shaping air utilizing parts which are common with a shaping air ring. That is to say, the coating machine can be constructed in a compact form by the use of a reduced number of parts.

(7) According to the present invention, a positioning mechanism is provided between the stationary ring and rotatable ring and adapted to retain the slider in either a coupling position in engagement with the coupling portion or a receded position away from the coupling portion.

At the outer receded position, the slider is retained away from the coupling portion on the rotational shaft by the positioning mechanism, leaving the rotational shaft in a freely rotatable state. On the other hand, at the inner coupling position, the slider is held in engagement with the coupling portion on the rotational shaft by the positioning mechanism, fixing and locking the rotational shaft against rotation.

Therefore, even if operator's hands are off the rotatable ring, the rotational shaft can be retained fixedly in fixed state, permitting to carry out the mounting or dismantling work of the rotary atomizing head in an efficient manner.

### BRIEF DESCRIPTION OF THE DRAWINGS

In the accompanying drawings:

FIG. 1 is a longitudinal sectional view of a rotary atomizing head type coating machine adopted as a first embodiment of the present invention;

FIG. 2 is a fragmentary longitudinal section showing on an enlarged scale a front portion of the rotary atomizing head type coating machine in FIG. 1;

FIG. 3 is a fragmentary longitudinal section showing on an enlarged scale a front portion of the rotary atomizing head type coating machine, taken in the direction of arrows III-III in FIG. 4;

FIG. 4 is a cross-sectional view showing on an enlarged scale a front portion of the rotary atomizing head type coating machine, taken in the direction of arrows IV-IV in FIG. 2;

FIG. 5 is a cross-sectional view showing on an enlarged scale a rotational shaft fixed against rotation by a couple of slide plates, taken in the same position as FIG. 4;

FIG. 6 is an exploded perspective view showing a stationary ring, a rotatable ring and a couple of slide plates in a disassembled state;

FIG. 7 is a left-hand side view showing a front side of the stationary ring alone;

FIG. 8 is a right-hand side view showing a rear side of the rotatable ring alone;

FIG. 9 is a fragmentary longitudinal section showing on an enlarged scale a front portion of a rotary atomizing head type coating machine adopted as a second embodiment of the invention;

FIG. 10 is a fragmentary longitudinal section showing on an enlarged scale a front portion of the rotary atomizing head type coating machine, taken in the direction of arrows X-X in FIG. 11;

FIG. 11 is a cross-sectional view showing on an enlarged scale a front portion of the rotary atomizing head type coating machine, taken in the direction of arrows XI-XI in FIG. 9;

FIG. 12 is a cross-sectional view showing on an enlarged scale a rotational shaft fixed by a couple of slide pins, taken in the same position as FIG. 11;

FIG. 13 is a front view of a stationary ring alone; and

FIG. 14 is a schematic illustration showing on an enlarged scale a rotatable ring being pressed against the action of a ring biasing member.

### BEST MODE FOR CARRYING OUT THE INVENTION

Hereafter, the rotary atomizing head type coating machine according to the present invention is described more particularly by way of its preferred embodiments with reference to the accompanying drawings.

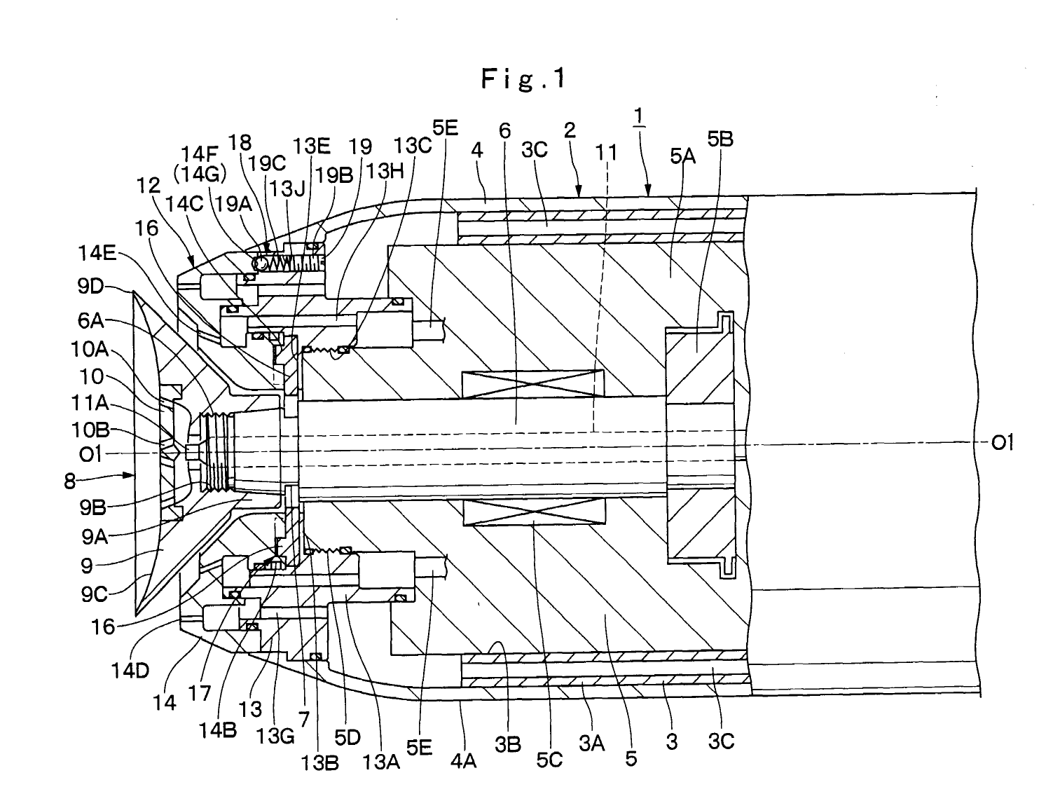

Referring first to FIGS. 1 through 8, there is shown a first embodiment of the present invention.

In FIG. 1, indicated at 1 is a rotary atomizing head type coating machine according to a first embodiment of the invention. This coating machine 1 is attached, for example, to a distal end of an arm (not shown) of a coating robot, a reciprocator or the like. The rotary atomizing head type coating machine 1 is largely constituted by a housing 2, an air motor 5, a rotational shaft 6, coupling portions 7, a rotary atomizing head 8, a feed tube 11 and a shaping air ring 12, which will be described hereinafter.

Denoted at 2 is a housing which defines an outer configuration of the coating machine 1. This housing 2 is composed of an inner main housing body 3, and an outer cover 4. In this instance, the main housing body 3 is provided with a tubular portion 3A on the front side, internally defining a hollow motor receptacle cavity 3B to accommodate an air motor 5 in a fit-in fashion. A plural number of air passages 3C are formed in an outer peripheral side of the main housing body 3 to circulate compressed air toward a shaping air ring 12 which will be described later on. On the other hand, the cover 4 is formed in a tubular shape to enshroud the main housing body 3, with an outer peripheral surface 4A gradually tapered in a forward direction to have a front section which is gradually reduced in diameter in a forward direction.

Indicated at 5 is an air motor which is fixedly fitted in the housing 2. This air motor 5 is powered by compressed air and put the rotary atomizing head 8 in high speed rotation of 3,000 to 100,000 rpm. The air motor 5 is largely constituted by a motor case 5A of a stepped cylindrical shape which is accommodated in the motor receptacle cavity 3B of the main housing body 3, a turbine 5B which is provided in a rear portion of the motor case 5A, an air bearing 5C which is provided internally of the motor case 5A to support a rotational shaft 6 rotatably, and the rotational shaft 6 which is rotatably supported by the air bearing 5C, as described hereinafter.

Further, a male screw 5D which is threaded into a female screw 13C of a stationary ring 13, which will be described hereinafter, is provided on an outer peripheral surface of the fore portion of the motor case 5A. Furthermore, an exhaust air passage 5E is provided at front side of the motor case 5A to exhaust compressed air supplied to put the turbine 5B in rotational drive.

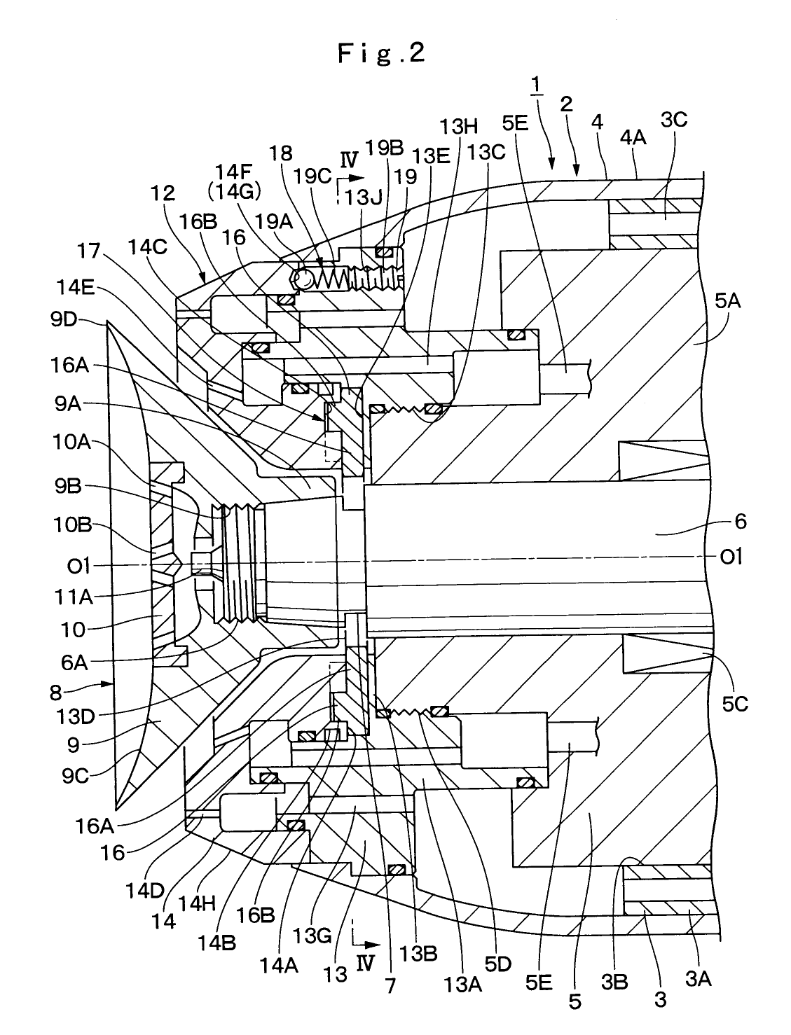

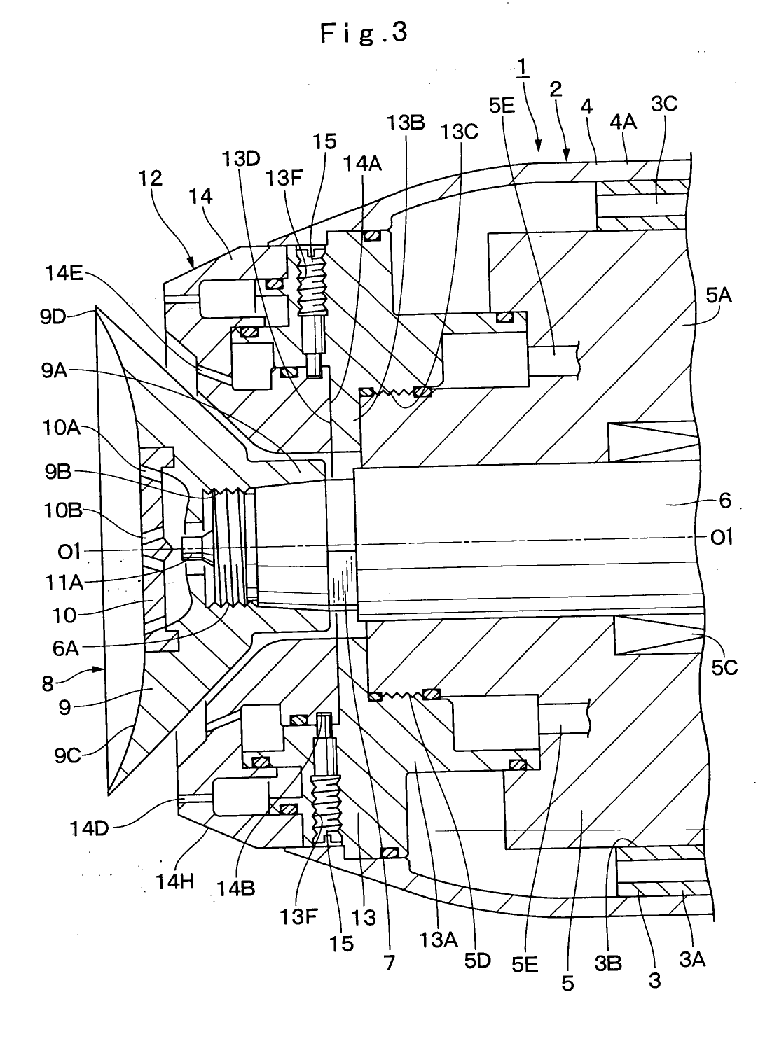

Designated at 6 is a hollow tubular rotational shaft of the air motor 5. This rotational shaft 6 is put in high speed rotation by the air motor 5 about a center axis O1-O1. Further, the rotational shaft 6 is rotatably supported in the motor case 5A by the air bearing 5C, and coupled with the air turbine 5B in a rear portion. On the other hand, as shown in FIGS. 2 and 3, a fore end portion of the rotational shaft 6 is projected on the front side of the motor case 5A, and provided with a male screw 6A around the circumference of the projected end portion for threaded engagement with a female screw 9B on the part of an atomizing head body 9, which will be described hereinafter. Further, provided on the projected fore end portion of the rotational shaft 6 are coupling portions 7 to be gripped by slide plates 16, which will be described hereinafter.

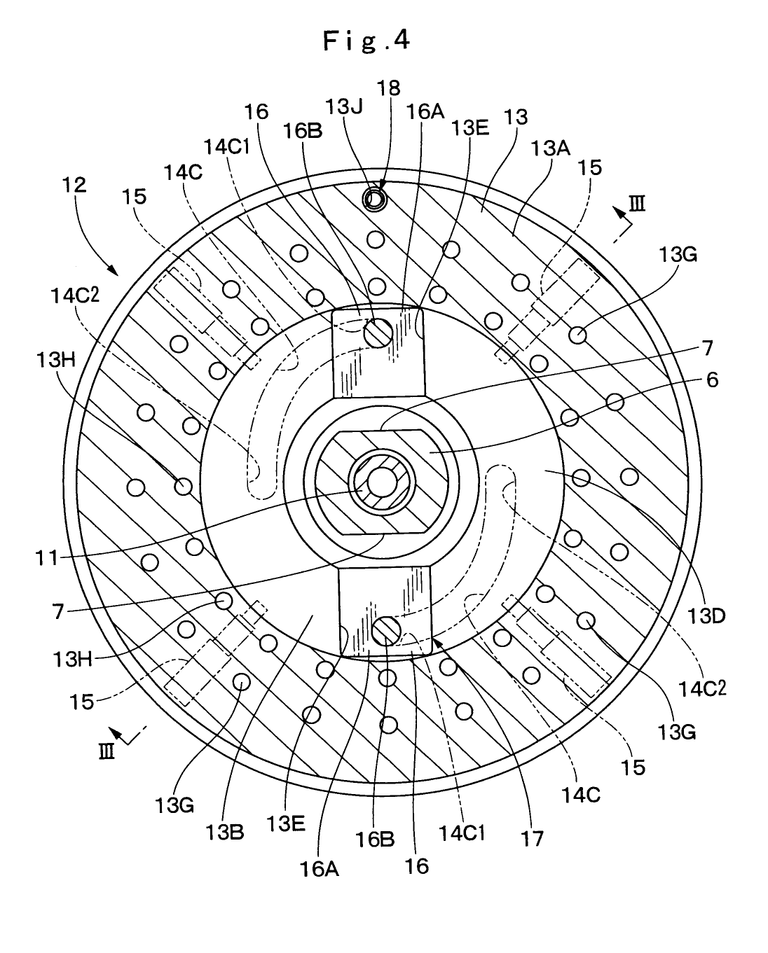

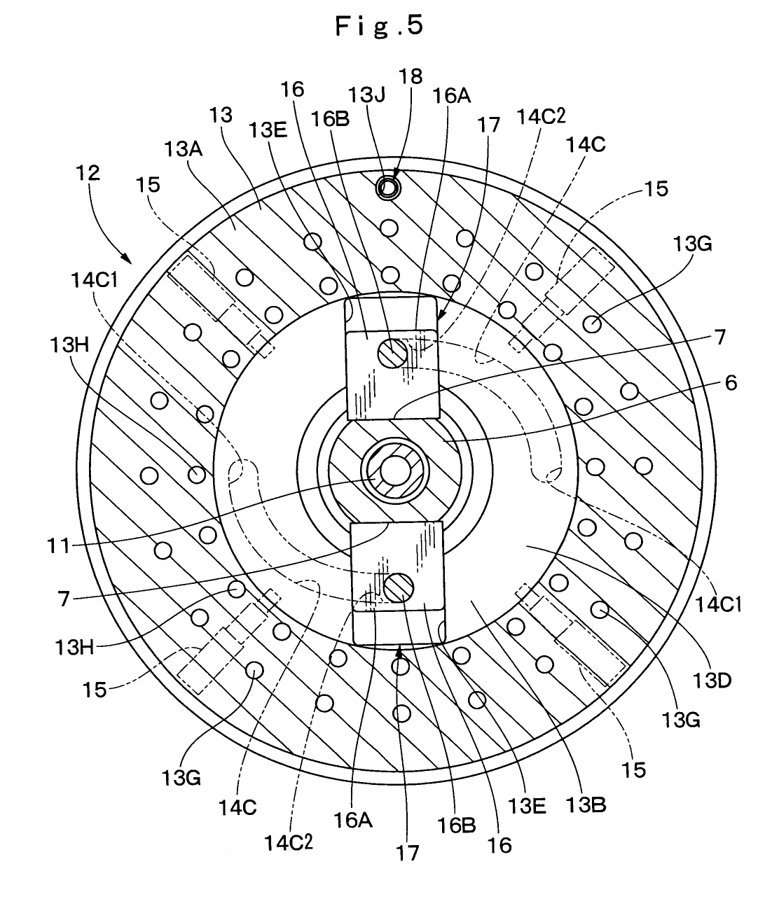

More particularly, indicated at 7 are a plural number of coupling portions, for example, a couple of coupling portions which are provided on the projected fore end portion of the rotational shaft 6. These coupling portions 7 are provided in axially coinciding positions on the circumference of the rotational shaft 6 between front side of the air motor 5 and rear side of the rotary atomizing head 8, which will be described hereinafter. Further, as shown in FIGS. 4 and 5, the coupling portions 7 are formed by notching circumferential portions of the rotational shaft 6 in a D-shape in section. The coupling portions 7 have the respective bottom surfaces disposed parallel with each other in radially aligned positions at the opposite sides of the center axis O1-O1 of the rotational shaft 6. As shown in FIG. 5, the coupling portions 7 are gripped by and between a couple of slide plates 16 to fix and lock the rotational shaft 6 against rotation.

Indicated at 8 is a rotary atomizing head which is mounted on a front end portion of the rotational shaft 6. To this rotary atomizing head 8 which is put in high speed rotation by the air motor 5, paint is supplied from a feed tube 11, which will be described hereinafter, and sprayed forward in the form of finely divided particles under the influence of centrifugal force. As shown in FIG. 2, the rotary atomizing head 8 is composed of an atomizing head body 9 which is formed in the shape of a bell or cup spreading in a forward direction from a rear side thereof, and a hub member 10 which is provided on the front side of the atomizing head body 9.

In this instance, the atomizing head body 9 is provided with a tubular rotational shaft mount portion 9A at a rear end, and a female screw 9B is tapped on the inner periphery of the rotational shaft mount portion 9A. On the other hand, the atomizing head body 9 is provided with a paint spreading surface 9C spreading in the form of a round plate on the front side, and releasing edges 9D are provided around the outer periphery of the paint spreading surface 9C to spray paint therefrom in the form of finely divided particles.

The hub member 10 is substantially in the form of a circular disc, and provided with a large number of paint outlet holes 10A (only two of which are shown in the drawing) bored in its outer periphery to let paint supplied from a feed tube 11 which will be described later on, flow onto the paint spreading surface 9C. In a center zone, a plural number of wash fluid outlet holes 10B (only two of which are shown in the drawing) are provided to let a wash fluid, which is supplied from the feed tube 11, flow out onto the front side.

Denoted at 11 is a feed tube which is passed through the rotational shaft 6. A fore end of the feed tube 11 is projected out of the rotational shaft 6 and extended into the rotary atomizing head 8. On the other hand, a base end of the feed tube 11 is connected through a gear pump or the like to a color changing valve system (not shown) which is capable of selectively supplying different paint colors or a wash fluid. A paint color or a wash fluid which is supplied from the color changing valve system is spurted into the rotary atomizing head 8 from a fore distal end 11A of the feed tube 11.

Indicated at 12 is a shaping air ring which is provided on the front side of the housing 2. This shaping air ring 12 is located in such a way as to circumvent the coupling portions 7, that is to say, located in a position between the fore end of the air motor 5 and rear end of the rotary atomizing head 8. From the shaping air ring 12, shaping air is spurted out toward the releasing edges 9D at the outer periphery of the rotary atomizing head 8 to put a pattern of sprayed paint particles in a desired shape.

In this instance, the shaping air ring 12 has a function of rotationally locking the rotational shaft 6 to prevent same from rotating together with the rotary atomizing head 8 when mounting or dismantling the latter. In order to fulfill this function of the rotational shaft 6, the shaping air ring 12 is formed of a stationary ring 13 and a rotatable ring 14 as described below.

Designated at 13 is a stationary ring of the shaping air ring 12, which is fixedly provided on the front side of the air motor 5 in a circumventing position relative to the coupling portions 7. The stationary ring 13 is formed in a stepped tubular shape, having a tubular portion 13A on the outer peripheral side and a reduced diameter portion 13B which is projected radially inward from the tubular portion 13A. A female screw 13C is tapped on the inner periphery of the tubular portion 13A on the rear side of the reduced diameter portion 13B for threaded engagement with a male screw 5D which is tapped around the outer periphery of a fore end portion of the motor case 5A. Further, a confronting surface 13D is provided on the front side of the reduced diameter portion 13B, in confronting relation with a confronting surface 14A on the side of a rotatable ring 14 which will be described later on.

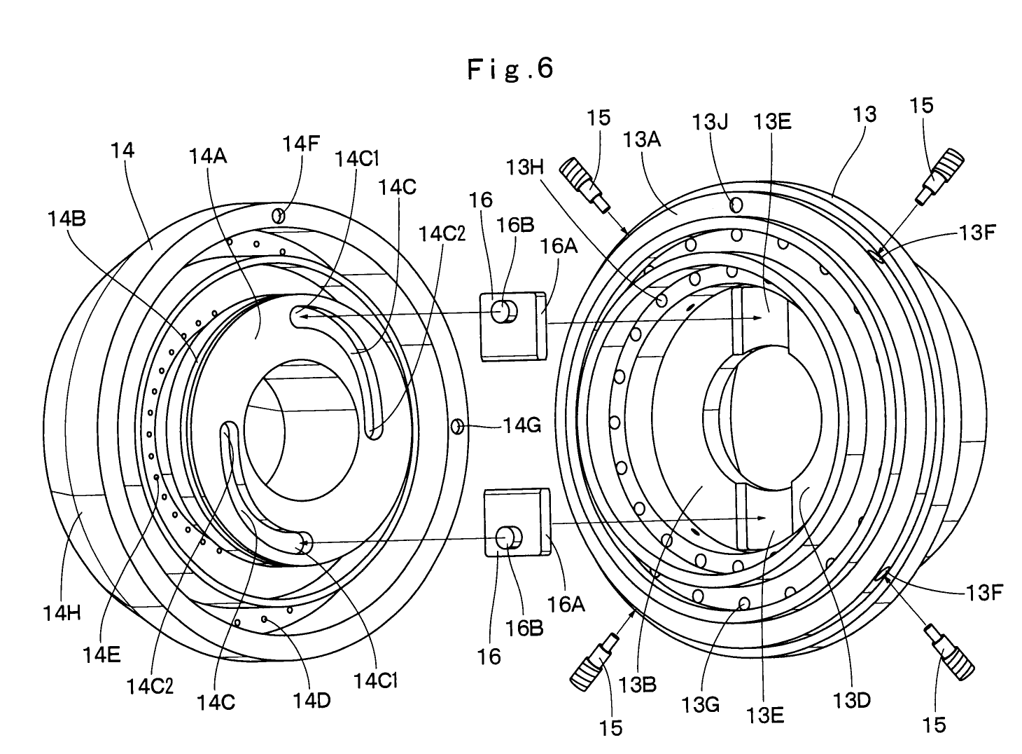

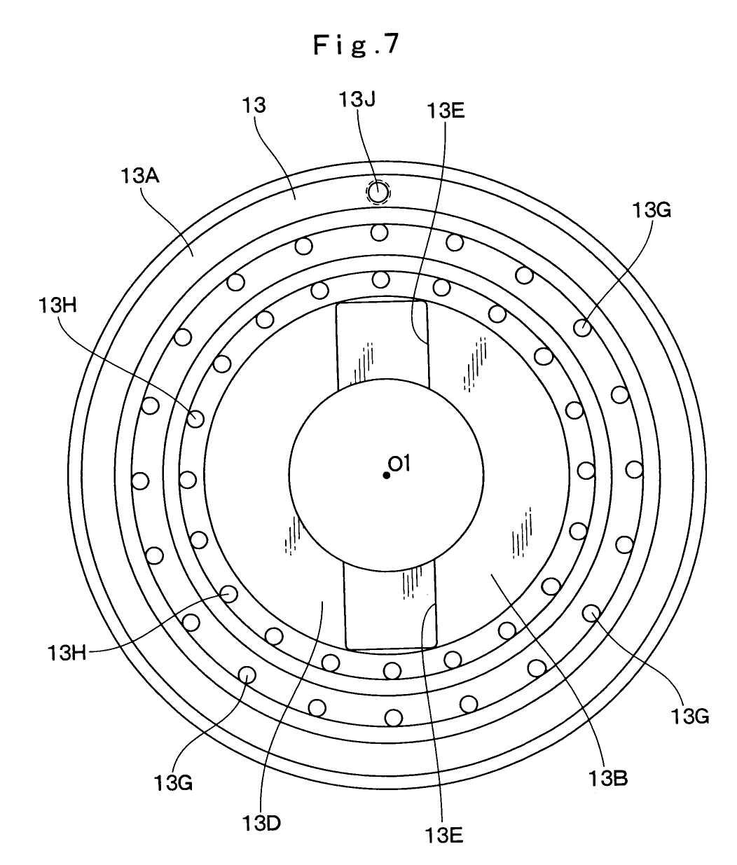

On the other hand, as shown in FIGS. 6 and 7, the stationary ring 13 is provided with a couple of radial direction guides 13E on the confronting surface 13D of the reduced diameter portion 13B. These radial direction guides 13E are located in circumferentially opposing 180 degree positions relative to each other and extended along a straight line drawn through and to the opposite sides of the center axis O1-O1. Together with rotational direction guides 14C on the rotatable ring 14 which will be described hereinafter, the radial direction guides 13E constitute a slider shift mechanism 17 thereby to guide the slide plates 16 movably in a radial direction of the rotational shaft 6. The radial direction guides 13E are each in the form of a wide square groove having a depth which is slightly greater than the thickness of slider portions 16A of slide plates 16.

Further, as shown in FIG. 3, at the front side of the tubular portion 13A, the stationary ring 13 is provided with a plural number of pin receptacle holes 13F extending radial directions. These pin receptacle holes 13F are provided in 2 to 6 positions at uniform angular intervals (in four positions in the case of the particular embodiment shown in the drawing) around the stationary ring 13. Further, the pin receptacle holes 13F are formed in axially coinciding positions relative to an annular groove 14B on the rotatable ring 14, which will be described hereinafter, when the latter is assembled with the stationary ring 13.

Further, a large number of shaping air passages 13G are formed in a circular row in an outer peripheral side of the tubular portion 13A. Each one of these shaping air passages 13G is communicated with an air passage 3C on the main housing body 3. Formed in a circular row on the radially inner side of the shaping air passages 13G are a larger number of assist air passages 13H which are communicated with an exhaust air passage 5E of the air motor 5.

Further, a stopper receptacle hole 13J is provided in the outer peripheral side of the tubular portion 13A, radially on an outer side of the shaping air passages 13G. A female screw is tapped on the inner periphery of this stopper receptacle hole 13J to receive a stopper 19 of a positioning mechanism 18, which will be described later on.

Indicated at 14 is a rotatable ring which is attached to the front side of and confront with the stationary ring 13. This rotatable ring 14 is located coaxially with the stationary ring 13 and rotatable relative to the latter. Further, the rotatable ring 14 is annular member in general and formed in V-shape in section, having a confronting surface 14A centrally at a rear end, face to face with the confronting surface 13D on the side of the stationary ring 13. Further, an annular groove 14B which is opened in a radially outward direction is formed around the outer periphery of the confronting surface 14A to receive fore distal ends of retainer pins 15, which will be described hereinafter, movably in a circumferential direction.

Two rotational direction guides 14C, each in the form of an arcuate groove opened in an axially rearward direction, are provided on the confronting surface 14A of the rotatable ring 14. Together with the afore-mentioned radial direction guides 13E on the stationary ring 13, these rotational direction guides 14C constitute a slider shift mechanism 17, which will be described hereinafter. Further, the rotational direction guides 14C are provided for shifting positions of the slide plates 16, which will be described hereinafter, in a radial direction of the rotational shaft 6, and coupling projections 16B on the slide plates 16 are slidably engaged with (fitted in) the rotational direction guides 14C. The two rotational direction guides 14C, which are paired with the radial direction guides 13E, are located correspondingly to the radial direction guides 13E in circumferentially opposing 180 degree positions.

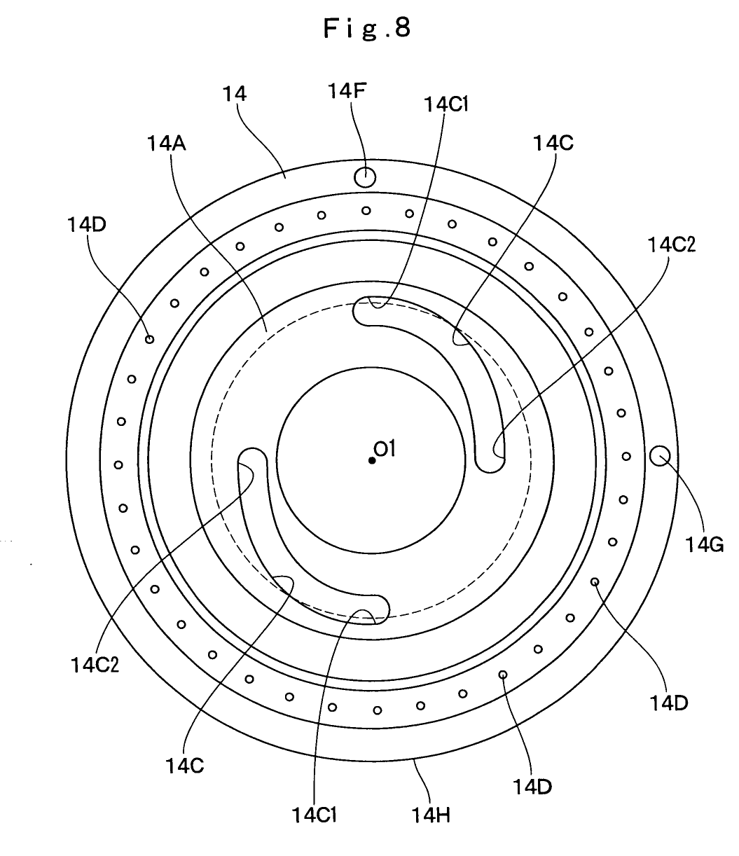

As shown in FIG. 8, each one of the rotational direction guides 14C is in the form of an arcuate groove which is continuously shifted in radial position in a rotational direction, more particularly, in the form of a groove of an arcuately curved eyebrow shape. Thus, one end 14C1 of the rotational direction guide 14C is located in an outer peripheral side (in a radially outer region) of the confronting surface 14A, the other end 14C2 which is turned approximately 90 degrees from the one end 14C1 is located in an inner peripheral side (toward a radially inner region) of the confronting face 14A.

On the other hand, a large number of shaping air outlet holes 14D are bored in a circular row in an outer peripheral side of the rotatable ring 14 and opened to the front side of the latter. Each one of these shaping air outlet holes 14D is communicated with a shaping air passage 13G on the side of the stationary ring 13. Further, a large number of assist air outlet holes 14E are bored in a circular row radially on the inner side of the shaping air outlet holes 14D. These assist air outlet holes 14E are each communicated with an assist air passage 13H on the part of the stationary ring 13.

Further, for example, a couple of positioning recesses 14F and 14G are provided in outer peripheral regions on the rear side of the rotatable ring 14. These positioning recesses 14F and 14G are brought into engagement with a ball member 19A of the stopper 19 which constitutes a positioning mechanism 18 on the side of the stationary ring 13. The positioning recess 14F serves to retain a slide plate 16, which will be described later on, fixedly at one end 14C1 of the rotational direction guide 14C, while the other positioning recess 14G serves to retain the slide plate 16 fixedly at the other end 14C2 of the rotational direction guide 14C. These positioning recesses 14F and 14G are located at radially coinciding positions relative to the stopper receptacle hole 13J and at an angular interval of approximately 90 degrees from each other.

Further, an outer peripheral surface 14H which determines the outer configuration of the rotatable ring 14 is exposed to outside on the front side of the cover 4 of the housing 2. In this instance, as shown in FIGS. 2 and 3, the outer peripheral surface 14H of the rotatable ring 14 is moderately tapered in a forward direction contiguously from an outer peripheral surface 4A of the cover 4. Thus, the rotatable ring 14 is smoothly continued from the cover 4 in such a way as to remove ups and downs in surface profile as much as possible from the outer periphery of the coating machine 1.

Indicated at 15 are a plural number of retainer pins (four retainer pins in the case of the particular embodiment shown) which are placed in the pin receptacle holes 13F on the stationary ring 13 (see FIG. 3). These retainer pins 15 are threaded into the pin receptacle holes 13F until the respective fore ends are engaged with the annular groove 14B on the side of the rotatable ring 14. Thus, the rotatable ring 14 is rotatably supported and retained in position against the stationary ring 13 by the respective retainer pins 15. After threading the retainer pins 15 into the pin receptacle holes 13F, both of the pin receptacle holes 13F and retainer pins 15 are concealed under the cover 4 to prevent intrusion of paint.

Indicated at 16 are a plural number of slide plates as sliders, for example, a couple of slide plates which are provided between the stationary ring 13 and the rotatable ring 14. These two slide plates 16 are located in radially confronting positions across the center axis O1-O1, and, by a radially inward displacement toward the rotational shaft 6, the respective slide plates 16 are brought into engagement with the coupling portions 7 uniformly from outside to fix and lock the rotational shaft 6 against rotation.

Further, as shown in FIGS. 2, 4 and 6, each slide plate 16 is in the form of a thin rectangular plate, and comprised of a slider portion 16A to be brought into and out of engagement with a coupling portion 7 at a fore distal end thereof, and a cylindrical coupling projection 16B provided on a surface of the slider portion 16A on the side of the rotatable ring 14 and projected toward the latter. The slider portion 16A of each slide plate 16 is slidably placed in the radial direction guide 13E on the stationary ring 13, with the coupling projection 16B slidably held in engagement with the rotational direction guide 14C on the side of the rotatable ring 14.

Denoted at 17 is a slider shift mechanism which is provided on the stationary ring 13 and the rotatable ring 14. This slider shift mechanism 17 is constituted by the radial direction guides 13E on the stationary ring 13 and the rotational direction guide 14C on the rotatable ring 14. The radial direction guides 13E of the slider shift mechanism 17 are engaged with the slider portions 16A of the slide plates 16 movably to the radial direction, while the rotational direction guides 14C are engaged with the coupling projections 16B of the slide plates 16.

In this instance, when the coupling projections 16B of the slide plates 16 are located at one ends 14C1 of the rotational direction guides 14C as shown in FIG. 4, the slider portions 16A are shifted to a position radially outward of the coupling portion 7 on the rotational shaft 6 by the slider shift mechanism 17, leaving the rotational shaft 6 in a freely rotatable state.

Upon turning the rotatable ring 14 approximately through 90 degrees in a rightward direction (in a clockwise direction), the slide plates 16 are guided to the radial direction by the radial direction guides 13E and shifted in a radially inward direction by the rotational direction guides 14C. As soon as the coupling projections 16B of the slide plates 16 reach the other ends 14C2 of the rotational direction guides 14C as shown in FIG. 5, the coupling portions 7 are gripped at the distal ends of the slider portions 16A to fix and lock the rotational shaft 6 against rotation.

In this manner, by the radial direction guides 13E and the rotational direction guides 14C of the slider shift mechanism 17, a rotational movement of the rotatable ring 14 is translated into a straight radial movement of the rotational shaft 6 to shift the slide plates 16 toward or away from the rotational shaft 6.

Therefore, when the coupling projection 16B is located at the one end 14C1 of the rotational direction guide 14C as shown in FIG. 4, the slider portion 16A of the slide plate 16 is located in a radially outer position away from the rotational shaft 6 to permit rotation of the latter. On the other hand, when the coupling projection 16B is located at the other end 14C2 of the rotational direction guide 14C as shown in FIG. 5, each coupling portion 7 is gripped at a fore distal end of the slider portion 16 to block rotation of the rotational shaft 6.

Indicated at 18 is a positioning mechanism which is provided between the stationary ring 13 and the rotatable ring 14 to serve as a positioning means (see FIGS. 1 and 2). By way of this positioning mechanism 18, the slide plates 16 are located either in an inner coupling position or an outer receded position, which will be described hereinafter. The positioning mechanism 18 is constituted by the afore-mentioned positioning recesses 14F and 14G on the rotatable ring 14 and a stopper 19 as described below.

Indicated at 19 is a stopper of the positioning mechanism 18 which is accommodated in a stopper receptacle hole 13J on the stationary ring 13. This stopper 19 constitutes the positioning mechanism 18 in cooperation with the positioning recesses 14F and 14G on the part of the rotatable ring 14. In this instance, the stopper 19 is composed of a ball member 19A which is adapted to partly nest in either the positioning recess 14F or 14G, a male screw 19B which is threaded into the stopper receptacle hole 13J, and a spring 19C which is interposed between the male screw 19B and the ball member 19A to constantly bias the ball member 19A toward the positioning recess 14F or 14G. According to a rotation of the rotatable ring 14, the spring 19C permits a part of the ball member 19A to protrude to the positioning recess 14F or 14G from the stopper receptacle hole 13J, and to retract the ball member 19A into the stopper receptacle hole 13J.

When the slide plates 16 are located in an outer receded position as shown in FIGS. 2 and 4, the ball member 19A of the stopper 19 is urged to nest in one positioning recess 14F on the rotatable ring 14. That is to say, by the positioning mechanism 18, each slide plate 16 is stopped in an outer receded position away from the coupling portion 7.

On the other hand, when the rotatable ring 14 is turned approximately through 90 degrees to bring the ball member 19A of the stopper 19 into engagement with the positioning recess 14G on the rotatable ring 14 as shown in FIG. 5, each slide plate 16 is stopped in an inner coupling position by the positioning mechanism 18, in engagement with the coupling portion 7 on the rotational shaft 6.

In this manner, by way of the positioning mechanism 18, each slide plate 16 (the rotatable ring 14) can be located and stopped in either the inner coupling position or the outer receded position, precluding possibilities of the slide plate 16 being shifted unexpectedly by an inadvertent rotational movement of the movable ring 14.

The rotary atomizing head type coating machine 1 according to the first embodiment has above-described arrangements, and a paint coating operation by use of the rotary atomizing head type coating machine 1 is described as follows.

In the first place, compressed air is supplied to the turbine 5B of the air motor 5 to put the rotary atomizing head 8 in high speed rotation together with the rotational shaft 6. In this state, a paint which has been selected by way of a color changing valve system is fed to the rotary atomizing head 8 from the feed tube 11 and sprayed forward from the rotary atomizing head 8 in the form of finely divided particles.

At this time, shaping air is spurted out from the respective shaping air outlet holes 14D in the rotatable ring 14 which constitutes the shaping air ring 12, thereby putting paint particles sprayed from the rotary atomizing head 8 in a suitable spray pattern in a flight toward a work piece to be painted.

Now, described below are actions of the slide plates 16 which take place when the rotatable ring 14 is turned relative to the stationary ring 13.

Firstly, at the time of a paint coating operation, the rotatable ring 14 is turned to the left (in a counterclockwise direction), when seen from front side, until it comes to a stop. With this counterclockwise rotation of the rotatable ring 14, as shown in FIG. 4, the two slide plates 16 are shifted radially outward by the slider shift mechanism 17, along the rotational direction guides 14C of the rotatable ring 14. Thus, the slide plates 16 are now located in outer receded positions apart from the rotational shaft 6 to permit rotation of the latter.

In this case, when the rotatable ring 14 is turned counterclockwise toward a left stop position, the ball member 19A of the stopper 19 of the positioning mechanism 18 partly drops into the positioning recess 14F to retain the rotatable ring 14 in the receded position. Thus, inadvertent inward movements of the slide plates 16 are prevented during a paint coating operation.

Now, for a cleaning operation to wash away deposited paint elaborately from the rotary atomizing head 8, the rotary atomizing head 8 needs to be dismantled from the rotational shaft 6. At the time of an elaborate washing operation, the rotatable ring 14 is turned to the right (in a clockwise direction), when seen from the front side. With this clockwise rotation of the rotatable ring 14, the two slide plates 16 are shifted radially inward by the slider shift mechanism 17, along the rotational direction guides 14C of the rotatable ring 14 as shown in FIG. 5, bringing the slide plates 16 into engagement with the coupling portions 7 on the rotational shafts 6 to fix and lock the later against rotation.

In this manner, when the rotatable ring 14 is turned clockwise toward the right stop position, the ball member 19A of the stopper 19 drops into the positioning recess 14G to retain the rotatable ring 14 in the coupling position. Thus, even if operator's hands are off the rotatable ring 14, the rotational shaft 6 can be retained fixedly in that stop position. Accordingly, an operator can readily dismantle the rotary atomizing head 8 from the rotational shaft 6 by gripping and unscrewing the same about the rotational shaft 6 which is now fixed and locked against rotation.

As described above, according to the first embodiment of the invention, a couple of coupling portions 7 are provided at the opposite sides of the rotational shaft 6, while the stationary ring 13 is mounted on the front side of the air motor 5, the rotatable ring 14 is provided rotatably on the stationary ring 13, and a couple of slide plates 16 are provided shiftably to the radial direction of the rotational shaft 6 on the stationary ring 13. Further, the slider shift mechanism 17 is provided between the stationary ring 13 and the rotatable ring 14 in such a way as to shift the slide plates 16 in a radial direction in relation with a rotation of the rotatable ring 14, bringing the respective slide plates 16 into and out of engagement with the coupling portions 7.

Accordingly, at the time of dismantling the rotary atomizing head 8 from the rotational shaft 6, for example, an operator grips and turns the rotatable ring 14 clockwise with one hand. Upon turning the rotatable ring 14, a rotation of the rotatable ring 14 is translated into a linear movement in a radial direction of the rotational shaft 6 by the slider shift mechanism 17 to shift the slide plates 16 in a radially inward direction toward the rotational shaft 6 for engagement with the coupling portions 7. As soon as the slide plates 16 are engaged with the coupling portions 7 in this manner, the rotational shaft 6 is fixed and locked against rotation. That is to say, the rotary atomizing head 8 alone is turned relative to the rotational shaft 6 and can be readily dismantled from the rotational shaft 6. Similarly, the rotary atomizing head 8 can be mounted on the rotational shaft 6 in a facilitated manner.

On the other hand, upon turning the rotatable ring 14 counterclockwise, the slide plates 16 are shifted by the slider shift mechanism 17 in a radially outward direction away from the coupling portions 7. As a result, the slide plates 16 are disengaged from the rotational shaft 6, leaving the latter in a freely rotatable state.

Thus, simply by one action of turning the rotatable ring 14 approximately through 90 degrees in a clockwise direction, the rotational shafts 6 can be fixed and locked against rotation. That is to say, the rotary atomizing head 8 can be mounted on or dismantled from the rotational shaft 6 in a very facilitated manner. This means that a washing operation, an assembling work or a part replacing job of the rotary atomizing head 8 can be carried out more easily, guaranteeing higher productivity and efficient maintenance and service.

Further, the coupling portions 7 are provided in two radially opposing positions across the center axis O1-O1 of the rotational shaft 6, and two slide plates 16 are also located in radially opposing positions across the center axis O1-O1. In this instance, the two slide plates 16 are adapted to grip the coupling portions 7 of the rotational shaft 6 from radially opposite sides.

Thus, even if a rotational force is applied to the rotational shaft 6 at the time of mounting or dismantling the rotary atomizing head 8, the rotational shaft 6 is fixed and locked against rotation by the two coupling portions 7 and the two slide plates 16 without a deviation from the center axis O1-O1. In addition, there is no possibility of an unduly large load being imposed on the rotational shaft 6, the air motor 5 or other component in a radial direction at the time of mounting or dismantling the rotary atomizing head 8, that is to say, there is no possibility of damages to the turbine 5B of the air motor 5 or to the air bearing 5C which might result in rotational failures. Thus, the above arrangements contribute to prolong the life span of the air motor 5 and the rotational shaft 6 as well, improving the quality of coatings and operational reliability of the machine.

On the other hand, the slider shift mechanism 17 is constituted by the radial direction guides 13E which are radially extended on across the confronting surface 13D of the stationary ring 13, and the rotational direction guides 14C in the form of arcuate grooves which are extended in the rotational direction with a shift in radial position on the confronting surface 14D of the rotatable ring 14. Thus, by the use of guides which are very simple in construction and easy to handle, the slider shift mechanism 17 can translate a rotational movement of the rotatable ring 14 into a straight radial movement of the rotational shaft 6.

The rotational direction guides 14C on the rotatable ring 14, which constitute the slider shift mechanism 17 are each in the form of a groove which is extended arcuately in the rotational direction with a shift in radial position. Therefore, the rotational direction guides 14C have a function of constantly holding the slide plates 16 against inadvertent movements. That is to say, the rotational direction guides 14C can prevent inadvertent contact of the slide plates 16 with the rotational shaft 6, making the machine a more reliable one.

Further, the stationary ring 13 and the rotatable ring 14 are located face to face on the front side of the air motor 5 in such a way that the slide plates 16 are concealed within the rotatable ring 14. Thus, the exterior of the machine can be put in a smooth form free of hollowed or projecting surface portions to suppress paint deposition. Besides, the rotatable ring 14 is smoothly connected from the cover 4, giving a better outer look to the machine.

Furthermore, the stationary ring 13 and the rotatable ring 14 are arranged to form the shaping air ring 12 to spurt shaping air toward the outer peripheral side of the rotary atomizing head 8. Therefore, modular parts can be used for the stationary ring 13 and the rotatable ring 14 as the shaping air ring 12. In this case, there is no necessity for separately providing a rotationally locking mechanism for the rotational shaft 6. Accordingly, the rotary atomizing head type coating machine 1 can be constructed in a compact form by the use of a reduced number of parts.

Further, the positioning mechanism 18 is provided between the stationary ring 13 and the rotatable ring 14, and constructed by a couple of positioning recesses 14F and 14G on the rotatable ring 14 and the stopper 19 which is accommodated in the stopper receptacle hole 13J on the stationary ring 13. This positioning mechanism 18 is adapted to locate the slide plates 16 in either the inner coupling position (shown in FIG. 5) engaged with the coupling portions 7 or the outer receded position (shown in FIGS. 2 and 4) separated away from the coupling portions 7. Thus, when located in the outer receded positions by the positioning mechanism 18, the rotational shaft 6 is freely rotatable, completely released from the respective slide plates 16. On the other hand, when located in the inner coupling positions by the positioning mechanism 18, the slide plates 16 are held in engagement with the rotational shaft 6, holding the latter in a fixed state while the rotary atomizing head 8 is mounted on or dismantled from the rotational shaft 6, permitting to carry out the mounting or dismantling work in an efficient manner.

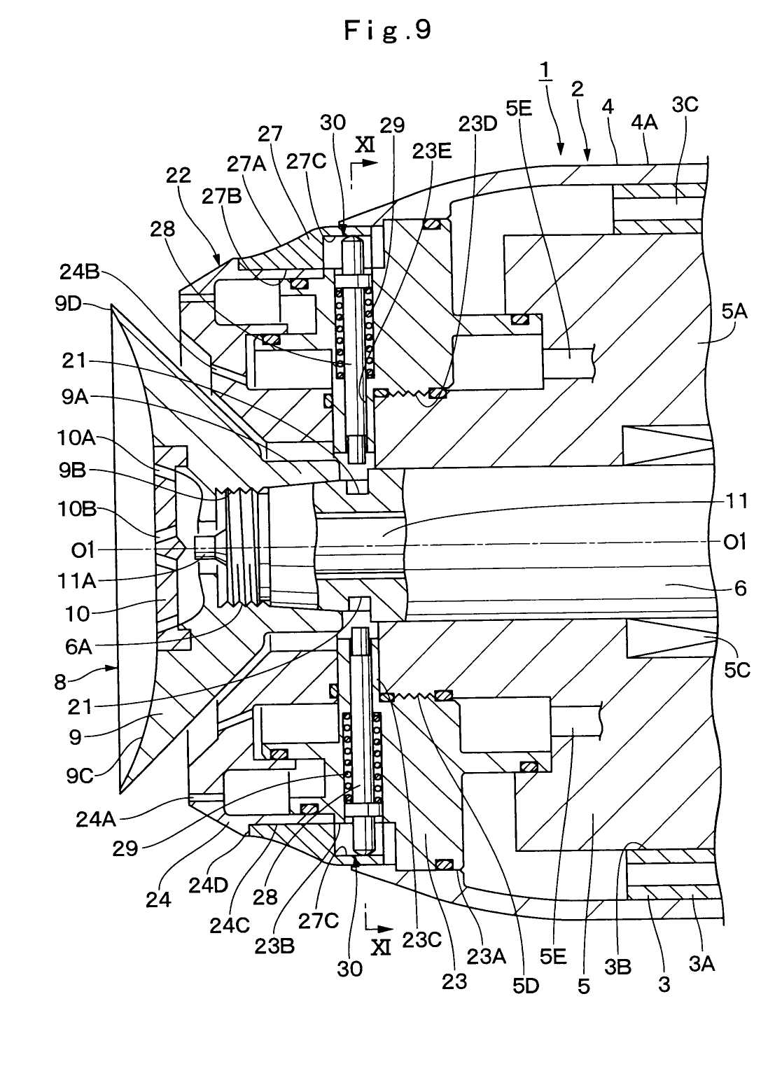

Turning now to FIGS. 9 through 14, there is shown a second embodiment of the present invention. This embodiment has a feature in that grooves extended to a rotational direction and having a varying depth are provided on the inner periphery side of the rotatable ring as rotational direction guides. In the following description of the second embodiment, those component parts which are identical with the counterparts in the foregoing first embodiment are simply designated by the same reference numerals or characters to avoid repetitions of similar explanations.

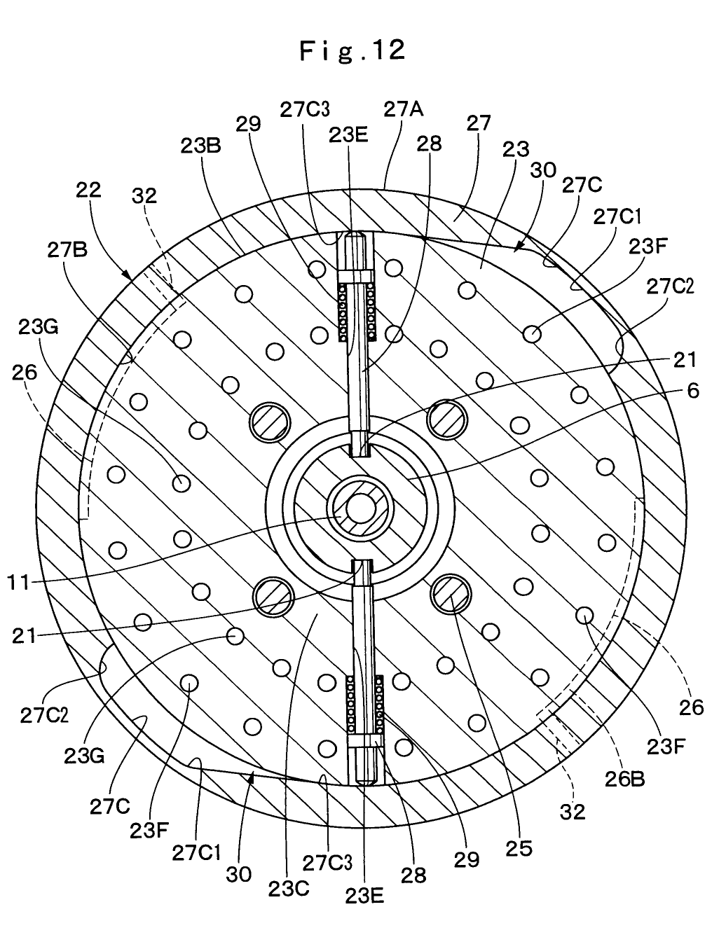

In FIG. 9, indicated at 21 are a couple of coupling portions which are provided on a fore end portion of the rotational shaft 6 in the second embodiment. These coupling portions 21 are each in the form of a bottomed round hole, and, as shown in FIG. 12, are gripped and engaged by slid pins 28 to fix the rotation of the rotational shaft 6 on the center axis O1-O1.

Indicated at 22 is a shaping air ring according to the second embodiment, which is located on the front side of the housing 2. Substantially in the same way as the shaping air ring 12 in the first embodiment, this shaping air ring 22 is adapted to spurt shaping air forward toward the rotary atomizing head 8 to put sprayed paint particle in a desired spray pattern. Further, the shaping air ring 22 also has a function of fixing and locking the rotational shaft 6 against rotation at the time of mounting or dismantling the rotary atomizing head 8.

Further, similarly to the shaping air ring 12 in the first embodiment, the shaping air ring 22 according to the second embodiment is constituted by a stationary ring 23 and a rotatable ring 27, which will be described hereinafter.

Namely, indicated at 23 is a stationary ring which constitutes the shaping air ring 22. This stationary ring 23 is mounted fixedly on the front side of the air motor 5. The stationary ring 23 is provided with stepped surfaces on its outer periphery, including a large diameter peripheral surface 23A on a rear side and a reduced small diameter peripheral surface 23B on a front side of the large diameter peripheral surface 23A. Further, the stationary ring 23 is provided with inward projections 23C being projected radially inward on its inner periphery. Furthermore, on the rear side of the inward projections 23C, the stationary ring 23 is provided with a female screw 23D on its inner periphery for threaded engagement with a male screw 5D on the side of the motor case 5.

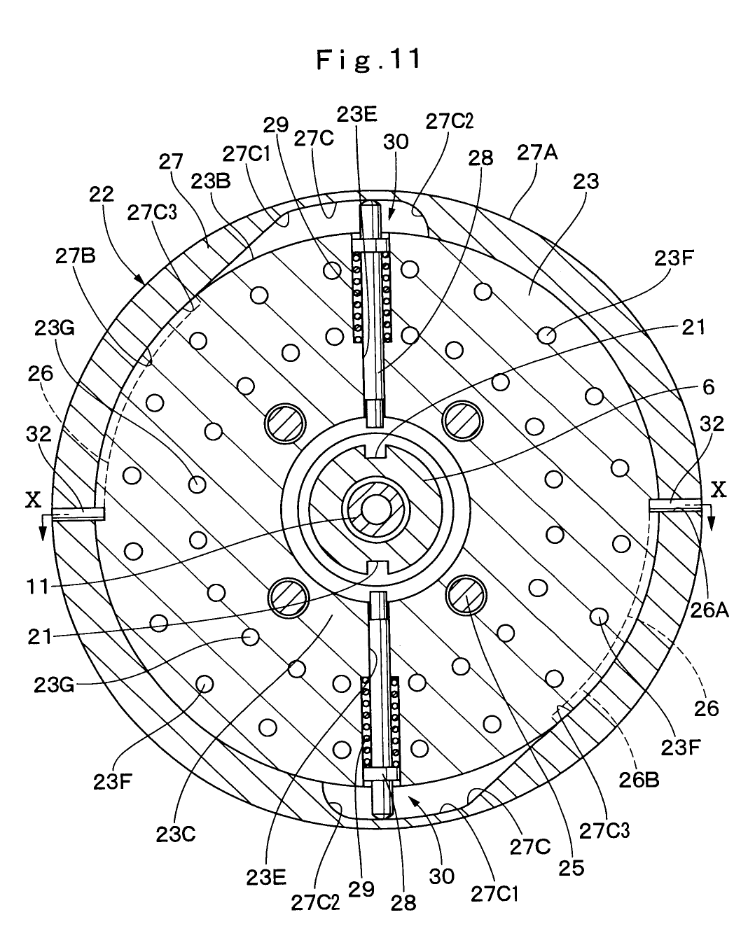

On the other hand, as shown in FIGS. 9 and 11, a couple of radial direction guides 23E are provided on the stationary ring 23, the radial direction guide 23E each being in the form of a straight through hole extending to the radial direction through the small diameter peripheral surface 23B and the inward projection 23C. These radial direction guides 23E are located in radially opposing 180 degree positions relative to each other and along a straight line passing through the center axis O1-O1. Each one of the radial direction guides 23E is adapted to guide a slide pin 28 movably in a radial direction toward and away from the rotational shaft 6. In cooperation with rotational direction guides 27C in the rotatable ring 27, these radial direction guides 23E constitute a slider shift mechanism 30.

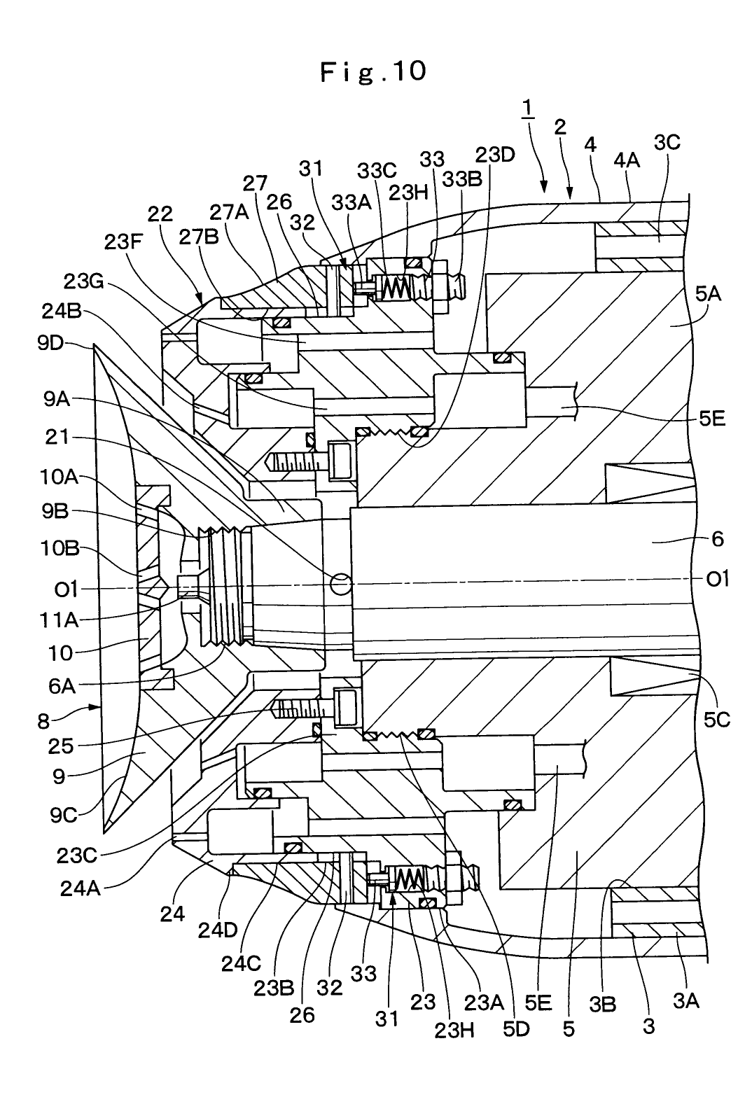

As shown in FIGS. 10 and 11, a large number of shaping air passages 23F are provided in a circular row on the stationary ring 23. In addition, assist air passages 23G are provided in a circular row on radially inner side of the shaping air passages 23F.

A couple of ring biasing member receptacle holes 23H are provided in radially opposing positions on the large diameter peripheral surface 23A of the stationary ring 23. These ring biasing member receptacle holes 23H are each extended in an axial direction and internally tapped with a female screw to receive a ring biasing member 33, which will be described later on. Further, formed in the outer peripheral surface of the stationary ring 23 is a guide groove 26 which constitutes part of a positioning mechanism.

Denoted at 24 is an air outlet casing which is a part of the stationary ring 23 and attached integrally to the front side of the stationary ring 23 by the use of a plural number of bolts 25. In an outer peripheral side of this air outlet casing 24, a large number of shaping air outlet holes 24A are bored in a circular row, along with a large number of assist air outlet holes 24B which are bored likewise in a circular row on a radially inner side of the shaping air outlet holes 24A. Provided on the outer peripheral side of the air outlet casing 24 are an indented outer peripheral surface 24C flush with the fore small diameter peripheral surface 23B of the stationary ring 23, and an annular projection 24D which is located on the front side and projected forward of the outer peripheral surface 24C. This annular projection 24D functions as an axial direction stopper when the rotatable ring 27 is biased forward by a ring biasing member 33, which will be described hereinafter.

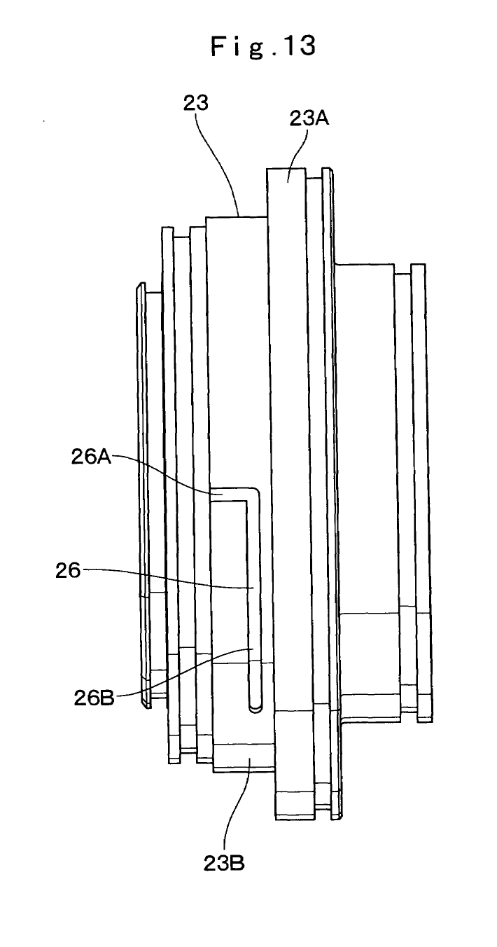

Denoted at 26 are a couple of guide grooves which are provided on the small diameter peripheral surface 23B of the stationary ring 23. These guide grooves 26 constitute positioning mechanisms 31 along with pins 32 and ring biasing members 33, which will be described hereinafter, and are located in radially opposing 180 degree positions relative to each other. Further, as shown in FIG. 13, the guide grooves 26 are each formed in L-shape and composed of a relatively short axial groove portion 26A extended axial direction and a relatively elongated circumferential groove portion 26B continued from a deepest rear end of the axial groove portion 26A in the circumferential direction. The circumferential groove portion 26B is formed by an angular range coinciding with that of each rotational direction guide 27C on the rotatable ring 27, which will be described hereinafter.

Indicated at 27 is a rotatable ring which is rotatably attached to the stationary ring 23 in such a way as to circumvent the latter radially from outer side. This rotatable ring 27 is slidably fitted on the small diameter peripheral surfaces 23B of the stationary ring 23 and the outer peripheral surface 24C of the air outlet casing 24 for displacements in an axial direction (in a forward or rearward direction) and in a circumferential direction (rotational direction) as well. The rotatable ring 27 is provided with an outer peripheral surface 27A which is smoothly continued to and from the annular projection 24D of the air outlet casing 24 and the cover 4 in a smooth outer peripheral shape.

On the other hand, a couple of rotational direction guides 27C are provided on an inner peripheral surface 27B of the rotatable ring 27 in positions radially outward of the radial direction guides 23E. Together with the radial direction guides 23E on the stationary ring 23, the rotational direction guides 27C constitute a slider shift mechanism 30, which will be described hereinafter. As shown in FIG. 11, the rotational direction guides 27C are each in the form of a groove which is extended in the rotational direction and varied in depth of a bottom surface 27C1.

Namely, the bottom surface 27C1 of each rotational direction guide 27C is formed in an arcuate shape and in a relatively large depth, rising abruptly to the level of the inner peripheral surface 27B at one end 27C2 and rising gradually to the inner peripheral surface 27B at the other end 27C3 in a continuous fashion. Thus, the rotational direction guide 27C acts to project the slide pin 28 in a radially outward direction between one end 27C2 and the other end 27C3 of the bottom surface 27C1 while depress the slide pin 28 in a radially inward direction when located on the inner peripheral surface 27B.

In this instance, the rotatable ring 27 in abutting engagement with the annular projection 24D of the air outlet casing 24 is axially spaced from the large diameter peripheral surface 23A of the stationary ring 23 by a predetermined distance. Therefore, the rotatable ring 27 is movable in an axial direction along the axial groove portion 26A of the guide groove 26. As soon as the rotatable ring 27 is moved up to a position on the large diameter peripheral surface 23A, the pin 32 comes into engagement with the circumferential groove portion 26B of the guide groove 26, putting the rotatable ring 27 in a rotatable state.

Indicated at 28 are a plural number of slide pins, for example, a couple of slide pins which are provided between the stationary ring 23 and rotatable ring 27 as sliders. The two slide pins 28 are located in radially opposing positions across the center axis O1-O1. Further, each slide pin 28 is accommodated in the radial direction guide 23E on the stationary ring 23 for movements in a radial direction. When the rotatable ring 27 is manually turned against the stationary ring 23, each slide pin 28 is shifted in a radially inward direction toward the rotational shaft 6 and its fore distal end is brought into engagement with the coupling portion 21, fixing and locking the rotational shaft 6 against rotation. By a biasing action of a spring member 29 which will be described hereinafter, the slide pin 28 is slidably abutted at its base end against the bottom surface 27C1 of the rotational direction guide 27C of the rotatable ring 27.

Denoted at 29 is a spring member which is provided within each radial direction guide 23E on the stationary ring 23. By this spring member 29, the slide pin 28 is constantly biased in radially outward direction to hold a base end of the slide pin 28 constantly in abutting engagement with the bottom surface 27C1 of the rotational direction guide 27C.

Indicated at 30 is a slider shift mechanism which is provided between the stationary ring 23 and rotatable ring 27. This slider shift mechanism 30 is constituted by the above-described radial direction guides 23E on the stationary ring 23 and the rotational direction guides 27C on the rotatable ring 27. Each slide pin 28 is radially movably received in the radial direction guide 23E of the slider shift mechanism 30, with a base end of the slide pin 28 in abutting engagement with the rotational direction guide 27C.

In this instance, as shown in FIG. 11, when at one end 27C2 of the bottom surface 27C1 of the rotational direction guide 27C is located a position of slide pin 28, the slide pin 28 is located in a radially outer receded position to permit free rotation of the rotational shaft 6 by the slider shift mechanism 30. On the other hand, when the rotatable ring 27 is turned to the right direction (in a clockwise direction) through an angle of 30 to 90 degree, for example, through an angle of 60 degrees, the slider shift mechanism 30 lets the slide pin 28 which is radially movable by the radial direction guide 23E move in a radially inward direction by the rotational direction guide 27C. As a result, as shown in FIG. 12, the fore ends of the respective slide pins 28 are brought into engagement with the coupling portions 21 to grip the rotational shaft 6 in a fixed state.

In this manner, by the cooperative actions of the radial direction guides 23E and rotational direction guides 27C of the slider shift mechanism 30, the slide pins 28 are shifted in a radially outward or inward direction in step with a rotational movement of the rotatable ring 27.

Indicated at 31 are positioning mechanisms which are provided as a positioning means between the stationary ring 23 and the rotatable ring 27. By these positioning mechanisms 31, each slide pin 28 is retained in either an inner coupling position or an outer receded position which will be described later on. Each positioning mechanism 31 is constituted by the guide groove 26 on the stationary ring 23 along with a pin 32 and a ring biasing member 33 which will be described hereinafter.

Indicated at 32 are a couple of pins which are provided on the rotatable ring 27. These pins 32 constitute positioning mechanisms 31 along with the aforementioned guide grooves 26 and ring biasing members 33 which will be described hereinafter. Each pin 32 is located approximately in a 90 degree position relative to one end 27C2 of the rotational direction guide 27C, having a fore distal end portion projected beyond the inner peripheral surface 27B and engaged with the guide groove 26.

Indicated at 33 are a couple of ring biasing members which are provided in each one of ring biasing member receptacle holes 23H on the stationary ring 23. Each ring biasing member 33 is constituted by a rod 33A which is projected toward the rotatable ring 27, a male screw 33B which is threaded in the ring biasing member receptacle hole 23H, and a spring 33C interposed between the male screw 33B and the rod 33A to bias the rod 33A toward the rotatable ring 27. Thus, the rotatable ring 27 is constantly biased in a forward direction through the rod 33A of each ring biasing member 33.

In this instance, the guide groove 26, pin 32 and ring biasing member 33 which constitute the positioning mechanism 31 are put in operation in the manner as follows. When the pin 32 is located in the axial groove portion 26A of the guide groove 26 as shown in FIGS. 10 and 11, the rotatable ring 27 is abutted against the annular projection 24D of the air outlet casing 24 by the action of the ring biasing member 33. At this time, the pin 32 is located in the axial groove portion 26A to block rotation of the rotatable ring 27, so that the respective slide pins 28 are retained in the outer receded positions.

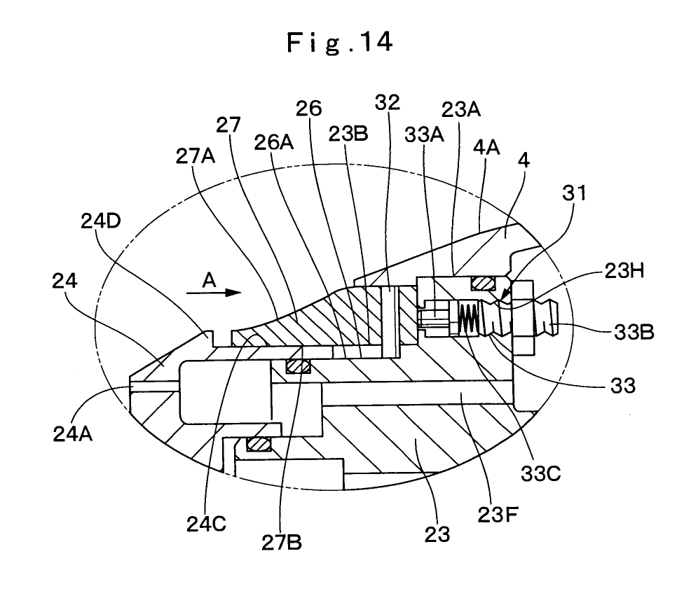

Now, at the time of turning the rotatable ring 27, it is pressed against the action of each ring biasing member 33 in the direction of arrow A in FIG. 14, urging each pin 32 to advance to the deepest portion of the axial groove portion 26A at the entrance to the circumferential groove portion 26B. In this state, the rotatable ring 27 can be turned in the direction of the circumferential groove portion 26B (in a clockwise direction), moving the pin 32 along the circumferential groove portion 26B. By moving the pins 32 along the respective circumferential groove portions 26B, each slide pin 28 is brought into engagement with the coupling portion 21 on the rotational shaft 6, as shown in FIG. 12.

At this time, the ring biasing members 33 act to retain the respective slide pins 28 in the coupled positions by pressing the pins 32 of the rotatable ring 27 against the circumferential groove portions 26B. In this manner, by way of the guide groove 26, pin 32 and ring biasing member 33 of each positioning mechanism 31, the slide pin 28 (the rotatable ring 27) can be retained in either the outer receded position or inner coupling position securely in such a manner as to prevent inadvertent rotation of the rotatable ring 27 and movements of the slide pin 28.

Now, described below are actions of the respective slide pins 28 when the rotatable ring 27 is turned relative to the stationary ring 23 of the second embodiment.

In the first place, at the time of a painting operation, as shown in FIGS. 10 and 11, the pins 32 of the rotatable ring 27 are each located in an axial groove portion 26A of the guide groove 26 to restrain rotational movements of the rotatable ring 27, holding each slide pin 28 in the outer receded position. At this time, by the slider shift mechanism 30, each slide pin 28 is shifted in a radially outward direction under the influence of the biasing force of the spring member 29 to permit rotation of the rotational shaft 6.

The rotary atomizing head 8 can be dismantled from the rotational shaft 6 in a facilitated manner as follows. In the first place, the rotatable ring 27, which is blocked against rotation by the axial groove portions 26A of the guide grooves 26, is pushed in the direction of arrow A against the ring biasing member 33 as shown in FIG. 14. By so doing, the pins 32 on the rotatable ring 27 are brought into the circumferential groove portions 26B to permit rightward (clockwise) rotation of the rotatable ring 27 along the circumferential groove portions 26B. As the rotatable ring 27 is turned in the rightward direction, the slide pins 28 are shifted radially inward by the respective slider shift mechanisms 30 and brought into engagement with the coupling portions 21 to hold the rotational shaft 6 in a fixed state.

Being arranged in the manner as described above, the second embodiment of the invention can produce substantially the same operational effects as the foregoing first embodiment. Especially in the case of the second embodiment, the rotatable ring 27 which is formed separately from shaping air passage can be provided in a relatively compact form and can be turned with a relatively weak force.

In the first embodiment described above, by way of example the coupling portions 7 on the rotational shaft 6, radial direction guides 13E of the stationary ring 13, rotational direction guides 14C of the rotatable ring 14 and slide plates 16 are provided in pairs across the center axis O1-O1. However, needless to say, the present invention is not limited to this particular example shown. Similar operational effects can be produced by providing a single coupling portion 7 on the rotational shaft 6, in association with a single radial direction guide 13E on the stationary ring 13, a single rotational direction guide 14C on the rotatable ring 14 and a single slide plate 16. Alternatively, the coupling portions 7 on the rotational shaft 6, radial direction guides 13E of the stationary ring 13, rotational direction guides 14C of the rotatable ring 14 and slide plates 16 may be provided in triplets at angular intervals of 60 degrees in the rotational direction. These modifications are similarly applicable to the second embodiment.

Further, for the convenience of assembling work and machining operations, the air outlet casing 24, constituting part of the stationary ring 23, is provided separately from the stationary ring and fixed to the latter by means of bolts 25. However, these parts may be formed as one integral structure, if desired.

1-7. (canceled)

8: A rotary atomizing head type coating machine comprising:
an air motor for putting a rotational shaft in rotation;
a rotary atomizing head threaded on a fore end portion of the rotational shaft of the air motor and adapted to spray paint supplied by rotation of the air motor:
a coupling portion provided on an outer peripheral surface of the rotational shaft at a position between the air motor and the rotary atomizing head;
a stationary ring provided on the air motor so as to circumvent the coupling portion;
a rotatable ring rotatably attached to the stationary ring;
a slider provided movably to the radial direction of the rotational shaft between the stationary ring and the rotatable ring;
a slider shift mechanism provided on the stationary ring and the rotatable ring to shift the slider in a radial direction of the rotational shaft in step with a rotational movement of the rotatable ring, bringing the slider into and out of engagement with the coupling portion; and
the slider fixing and locking the rotation of the rotational shaft when engaged with the coupling portion by the slider shift mechanism, and the slider leaving the rotational shaft in a rotatable state when shifted radially away from the coupling portion.

9: A rotary atomizing head type coating machine as defined in claim 8, wherein the coupling portion is provided at a plural number of positions on and around a circumferential surface of the rotational shaft, and a plural number of the sliders are provided in association with a corresponding number of the coupling portions.

10: A rotary atomizing head type coating machine as defined in claim 8, wherein the slider shift mechanism comprises:
a radial direction guide provided on the stationary ring to guide the slider straight in a radial direction of the rotational shaft; and
a rotational direction guide provided on the rotatable ring to shift the slider in a radially inward or outward direction along the radial direction guide in step with a rotational movement of the rotatable ring.

11: A rotary atomizing head type coating machine as defined in claim 10, wherein
the stationary ring and the rotatable ring are confronted face to face on the front side of the air motor;
the radial direction guide is formed straight in a radial direction on a confronting surface of the stationary ring;
the rotational direction guide in a form of an arcuate groove extended to a rotational direction and displaced in a radial direction is provided on a confronting surface of the rotatable ring; and
the slider is engaged with both of the radial direction guide and the rotational direction guide.

12: A rotary atomizing head type coating machine as defined in claim 10, wherein
the rotatable ring is located so as to circumvent the stationary ring from an outer peripheral side;
the radial direction guide extends straight in a radial direction on the stationary ring inward of the rotatable ring;
the rotational direction guide in a form of a groove extended to a rotational direction and having a varying depth is formed on inner peripheral side of the rotatable ring; and
the slider is held in engagement with both of the radial direction guide and the rotational direction guide.

13: A rotary atomizing head type coating machine as defined in claim 8, wherein the stationary ring and the rotatable ring are adapted to form a shaping air ring to spurt shaping air toward the rotary atomizing head.

14: A rotary atomizing head type coating machine as defined in claim 9, wherein the stationary ring and the rotatable ring are adapted to form a shaping air ring to spurt shaping air toward the rotary atomizing head.

15: A rotary atomizing head type coating machine as defined in claim 10, wherein the stationary ring and the rotatable ring are adapted to form a shaping air ring to spurt shaping air toward the rotary atomizing head.

16: A rotary atomizing head type coating machine as defined in claim 12, wherein the stationary ring and the rotatable ring are adapted to form a shaping air ring to spurt shaping air toward the rotary atomizing head.

17: A rotary atomizing head type coating machine as defined in claim 8, wherein a positioning mechanism is provided between the stationary ring and rotatable ring and adapted to retain the slider in either a coupling position in engagement with the coupling portion or a receded position away from the coupling portion.

18: A rotary atomizing head type coating machine as defined in claim 9, wherein a positioning mechanism is provided between the stationary ring and rotatable ring and adapted to retain the slider in either a coupling position in engagement with the coupling portion or a receded position away from the coupling portion.

19: A rotary atomizing head type coating machine as defined in claim 10, wherein a positioning mechanism is provided between the stationary ring and rotatable ring and adapted to retain the slider in either a coupling position in engagement with the coupling portion or a receded position away from the coupling portion.

20: A rotary atomizing head type coating machine as defined in claim 11, wherein a positioning mechanism is provided between the stationary ring and rotatable ring and adapted to retain the slider in either a coupling position in engagement with the coupling portion or a receded position away from the coupling portion.

21: A rotary atomizing head type coating machine as defined in claim 12, wherein a positioning mechanism is provided between the stationary ring and rotatable ring and adapted to retain the slider in either a coupling position in engagement with the coupling portion or a receded position away from the coupling portion.

22: A rotary atomizing head type coating machine as defined in claim 11, wherein the stationary ring and the rotatable ring are adapted to form a shaping air ring to spurt shaping air toward the rotary atomizing head.
